(19) United States
(12) Patent Application Publication
(10) Pub. No.: US 2005/0175038 A1
(43) Pub. Date: Aug. 11, 2005

(54) Method and apparatus for synchronizing wireless location servers

(76) Inventors: John Carlson, Dulles, VA (US); Martin Alles, Hamilton Parish (BM); George Maher, Herndon, VA (US)

Correspondence Address: DUANE MORRIS LLP, Suite 700, 1667 K Street, N.W., Washington, DC, 20006, US

(21) Appl. No.: 11/033,165

(22) Filed: Jan. 12, 2005

Related U.S. Application Data
(60) Provisional application No. 60/535,551, filed on Jan. 12, 2004.

(51) Int. Cl. H04J 3/06

(52) U.S. Cl. 370/503; 370/350

(57) ABSTRACT

The disclosure generally relates to techniques for time acquisition, synchronization and location estimation when the GPS signal condition deteriorate or when the signal is unavailable. In one embodiment, the disclosure relates to a processor for detecting clock error of a wireless location sensor (WLS) in a communication network having several wireless sensors, the processor programmed with instructions for determining clock error of an asynchronous WLS. The instructions include identifying a first WLS having asynchronous clock and a second WLS having synchronous clock; directing each of the first and the second WLS to detect a broadcast transmitted from a transmission station of known location and report an actual time of arrival at each of the first and the second WLS; computing an expected time of arrival of the broadcast at the first WLS as a function of the distance between the first WLS and the second WLS; and determining a clock error at the first WLS as a function of the expected time of arrival and the actual time of arrival of the broadcast at the first WLS.

The instant disclosure claims benefit to the filing date of Provisional Application No. 60/535,551 filed Jan. 12, 2004, the specification of which is incorporated herein in its entirety.

### BACKGROUND

The instant disclosure generally relates to network overlay location systems such as those used with E911 wireless locating protocols. Conventional techniques used to locate a mobile wireless transceiver include time of arrival (TOA), time difference of arrival (TDOA) and angle of arrival (AOA). Often a combination of two or more technique is used to locate the mobile. The conventional techniques measure time of arrival using a wireless location sensor (WLS), typically co-located with a conventional wireless telecommunications base station. The WLS measures the time of arrival of a particular portion of the mobile unit's transmitted signal using a standard time system which is a common time reference across WLS units participating in the location estimate. Generally, the common time standard is based on GPS time dictated by the GPS satellite.

Some network overlay geolocation systems require each WLS to maintain an internal clock. A clock that is properly synchronized with the other WLS clocks is essential so that all WLS can make time measurements on the arrival times of the target signals based on the same time reference. Without this synchronization, any scheme that attempts to derive other information has no absolute point of reference and compromises the quality of the location estimate.

The GPS satellites are not always visible to a WLS and thus a GPS time referenced clock at the WLS may not be synchronous with the clocks at other WLSs. For example, at certain locations the GPS signal may be obstructed by transitory or weather-related conditions while at other locations the GPS signal maybe permanently blocked due to geographical and topographical obstructions. In certain environments, a subset of WLS may not have an acceptable GPS reception. The subset (herein, bad location sensors) and the subset that has an acceptable GPS reception (herein, good location sensors) may oscillate over time as a function of local conditions, the weather and the movement of GPS satellites. Typically, each WLS using GPS information (or the lack thereof) is capable of verifying whether its clock is correct. Thus, the good location sensors and the bad sensors know their clock status and report to a Master Unit (MU). The MU may reside at a conventional Geolocation Control Subsystem (GCS). In the case of GPS dropouts, where a good clock goes bad, it has been found that a conventional WLS can maintain over an hour of acceptable holdover. For example a quartz-based oscillator within the WLS can maintain error of less than 100 nanoseconds. For even greater accuracy with less drift a Rubidium crystal timing reference may be used. Thus, the rate at which location sensors change their status (i.e., good to bad or vice versa) is relatively slow and certainly much larger than the time interval associated with the processing of a location request.

There is a need to create new functionality to enable network overlay geolocation systems to work in areas where global positioning systems (GPS) signals are periodically not available due to reduced satellite visibility or where GPS signals are never available due to obstruction.

### SUMMARY OF THE DISCLOSURE

In one embodiment, the disclosure relates to a processor for detecting clock error of a wireless location sensor (WLS) in a communication network having several WLSs. The processor is programmed with instructions for determining clock error of an asynchronous WLS, the instructions comprising identifying a first WLS having an asynchronous clock and a second WLS having a synchronous clock; directing each of the first and the second WLS to detect a broadcast transmitted from a transmission station of known location and report an actual time of arrival at each of the first and the second WLS; computing an expected time of arrival of the broadcast at the first WLS as a function of the distance between the transmission station and the first and second WLSs; and determining a clock error at the first WLS as a function of the expected time of arrival and the actual time of arrival of the broadcast at the first WLS.

In another embodiment, the disclosure relates to a machine-readable medium having stored thereon a plurality of executable instructions to be executed by a processor to determine clock error associated with one of a plurality of Wireless Location Sensors. The method includes identifying a first, a second and a third WLS in communication with the processor; directing each WLS to acquire a first broadcast transmitted from a first transmission station and a second broadcast transmitted from a second transmission station, each WLS reporting an actual time of arrival at each of the first, second and third WLS; computing an expected time of arrival at the third WLS for each of the first and the second broadcast as a function of the distance between all WLSs and at least one of the first or the second transmission stations; and determining a clock error at the third WLS as a function of the expected time of arrival and the actual time of arrival for at least one of the first and second broadcast.

In another embodiment, the disclosure relates to a machine-readable medium having stored thereon a plurality of executable instructions to be executed by a processor to determine clock error associated with one of a plurality of Wireless Location Sensors. The method includes identifying a plurality of WLSs in communication with the processor; directing each WLS to acquire a first broadcast transmitted from a first transmission station and a second broadcast transmitted from a second transmission station, each WLS reporting an actual time of arrival at each of the first, second and third WLS; computing an expected time of arrival at the third WLS for each of the first and the second broadcast as a function of the distance between all WLSs and at least one of the first or the second transmission stations; and determining a clock error at the third WLS as a function of the expected time of arrival and the actual time of arrival for at least one of the first and second broadcast.

In still another embodiment, the disclosure relates to a processor for detecting clock error of a wireless location sensor (WLS) in a communication network having several wireless sensors, the processor programmed with instructions for determining clock error of an asynchronous WLS, the instructions comprising identifying a first WLS having asynchronous clock and a plurality of WLS having synchronous clocks, each WLS having a known position; directing each of the first and the second plurality of WLS to detect a broadcast transmitted from a mobile transmission station and report an actual time of arrival at each of the first and the plurality of WLS; determining an approximate location for the mobile transmitter at the time of transmission from the time of arrival at the plurality of WLS; computing an expected time of arrival of the broadcast at the first WLS as a function of the distances between all WLSs and the mobile transmitter; and determining the clock error of the first WLS as a function of the expected time of arrival and the actual time of arrival of the broadcast at the first WLS.

In still another embodiment, the disclosure relates to a machine-readable medium having stored thereon a plurality of executable instructions to be executed by a processor to determine clock error associated with one of a plurality of Wireless Location Sensors (“WLS”). The instructions include identifying a first, a second and a third WLS in communication with the processor; directing each WLS to acquire a first broadcast transmitted from a first transmission station and a second broadcast transmitted from a second transmission station, each WLS reporting an actual time of arrival at each of the first, second and third WLS; computing an expected time of arrival at the third WLS for each of the first and the second broadcast as a function of the distances between all WLSs and at least one of the first or the second transmission stations; adjusting the expected time of arrival at the third WLS to offset multipath propagation distance; and determining a clock error at the third WLS as a function of the adjusted expected time of arrival and the actual time of arrival for at least one of the first and second broadcast.

According to another embodiment of the disclosure known multipath associated with a particular wireless sensor can be used to derive a weighting factor (or adjustment coefficient) to be used in computations concerning the wireless sensor. For example, a processor can be programmed with machine-executable instructions for weighting the location information provided by one of wireless location sensors (WLS) in a wireless network. The instructions can include (1) identifying a first, a second and a third WLS in communication with the processor; (2) directing each WLS to acquire a first broadcast signal transmitted from a first transmission station and a second broadcast signal transmitted from a second transmission station, each WLS reporting an actual time of arrival at each of the first, second and third WLS; (3) computing an expected time of arrival at the third WLS for each of the first and the second broadcast signals as a function of the distance between all WLSs and at least one of the first or the second transmission stations; (4) adjusting the expected time of arrival at the third WLS to offset multipath propagation distance; (5) determining a clock error offset at the third WLS as a function of the adjusted expected time of arrival and the actual time of arrival for at least one of the first and second broadcast; and (6) using the clock error offset to compute a weighting factor to be applied to location related measurements provided by the third WLS.

According to still another embodiment, the disclosure relates to a machine-readable medium having stored thereon a plurality of executable instructions to be executed by a processor to determine multipath interference between a pair of Wireless Location Sensors in a network of multiple wireless sensors. The executable instructions may include (1) identifying a first WLS and a second WLS capable of communication with each other; (2) transmitting a first plurality of signals from the first WLS to the second WLS; (3) defining a first group of times of arrival of the first plurality of signals received at the second WLS; (4) transmitting a second plurality of signals from the second WLS to the first WLS; (5) defining a second group of times of arrival of the second plurality of signals received at the first WLS; and (6) determining the presence of multipath interference between the first and second WLS as a function of the time shifts between the first and second groups.

In still another embodiment, the disclosure relates to a method and apparatus for determining a location offset as a function of clock error associated with a wireless location sensor as a function of its clock error. The method including identifying a mobile transceiver in communication with the first WLS and a plurality of secondary location sensors; assessing the location of the mobile as a function of signal propagation time between the mobile and the secondary location sensors; assessing the location of the mobile transmitter as a function of signal propagation time between the mobile and the first WLS; determine a location offset from the location of the mobile as assessed by each of the first WLS and the secondary sensors; and determining the clock error for the first WLS as a function of the location offset and the distance between the mobile transmitter and the first WLS.

### BRIEF DESCRIPTION OF THE DRAWINGS

FIG. 1 is a schematic representation of two wireless transmission stations implementing an embodiment of the disclosure;

FIG. 2 is a schematic representation of a plurality of wireless transmission stations implementing an embodiment of the disclosure; and

FIG. 3 is a schematic representation of a plurality of wireless transmission stations and a mobile transmission station implementing an embodiment of the disclosure.

### DETAILED DESCRIPTION

FIG. 1 is a schematic representation of two wireless transmission stations implementing an embodiment of the disclosure. Referring to FIG. 1, base station 110 is equipped with antenna 110 and is co-located with WLS 1. Base station 100 is also in direct communication with WLS 1. Similarly, base station 100 is equipped with antenna 150 and is co-located with WLS 2. Base stations 100 and 130 communicate with master unit (MU) 180 through land lines 170.

According to an embodiment of the disclosure, a method for synchronizing a WLS with a bad clock (or without a clock) includes the steps of identifying WLS 1 having an asynchronous clock and WLS 2 having a synchronous clock; directing each WLS to detect a broadcast transmitted from a transmission station of known location and report an actual time of arrival at the each WLS; computing an expected time of arrival of the broadcast at WLS 1 as a function of the distance between the transmitter and each of WLS 1 and WLS 2, or more generally as a function of the locations of the transmitter and WLSs; and determining a clock error at WLS 1 as a function of the expected time of arrival and the actual time of arrival of the broadcast at WLS 1.

Alternately, the WLS can monitor its own clock status and report its status to a MU. For example, a WLS can classify its clock as bad if it has not received GPS signals for a predetermined period of time. The predetermined period of time can be selected as a function of the drift of the affected clock or other time dependent error.

The step of identifying a WLS 1 having an asynchronous clock can be accomplished at master unit 180. Since master unit 180 is in communication with each of WLS 1 and WLS 2, the master unit is able to assess whether a wireless sensor is asynchronous as compared with a centralized clock or as compared with other wireless sensors. For example, in one embodiment master unit 180 can simultaneously communicate with a multitude of wireless sensors and classify the sensors in subsets of good and bad sensors based on their reported internal clocks. In addition, master unit 180 can maintain an internal clock and use any of a WLS clock from the internal clock to determine bad WLS. For example, master unit 180 can make an initial assessment that WLS 1 is off by 0.566 nanoseconds as compared with WLS 2 or that WLS 1 off by 0.5 nanoseconds as compared with master unit's internal clock. Since the internal clock of a wireless sensor is disciplined by GPS satellites, it follows that synchronizing against WLS 2 would be more accurate than synchronizing against the internal clock of master unit 180.

Once a bad WLS has been identified, master unit 180 can direct each WLS 1 and WLS 2 to detect a broadcast transmitted from a known transmitter (not shown) and report an actual time of arrival at each of the first and the second WLS. The master unit, considering an estimated clock offset at WLS 1, can also dictate a duration for receiving the broadcast. In the exemplary embodiment of FIG. 1, WLS 2 having a synchronized clock, transmits a signal to WLS 1 having asynchronous clock and reports the transmission time (according to WLS2's clock) to master unit 180. The signal can be in the form of a broadcast control channel (BCCH) or any other regularly transmitted beacon from a base station.

Simultaneous or sequential with requesting a broadcast from base station 130, master unit 180 may instruct WLS 1 to receive the broadcast from base station 130 and report the time of arrival to master unit 180. Knowing the broadcast time and the distance between base station 130 (co-located with WLS 2) and base station 100 (co-located with WLS 1), master unit 180 can compute an expected arrival time in units of time. The expected time of arrival can then be compared with the reported TOA (i.e., actual TOA) from WLS 2 to estimate clock error at WLS 2. The foregoing steps can be mathematically expressed as:
T₁₂=d₁₂+D₁+n₁₂ (1)

In equation (1) T₁₂ denotes the mean (or median) TOA of the BCCH bursts from base station 130 to base station 100, respectively co-located with WLS 2 and WLS 1. D₁ is the clock error at WLS 1; d₁₂ is the distance between WLS 1 and WLS 2; and n₁₂ is a noise term associated with the measurement process. Among others, noise may be a function of the accuracy of good WLS (i.e., WLS 2), the accuracy of the TOA algorithm, the impact of multipath and the signal-to-noise ratio (SNR) of the broadcast. As will be discussed further below, the noise term can be overcome by taking an average (or the maximum likelihood estimate) based on measurements for multiple broadcasts from WLS 2 to WLS 1.

The measurement of TOA can be the mean (or median) of all relevant measurements for WLS 1 and WLS 2, or it maybe a single measurement. In the first case the statistics of the noise may be derived by assuming the noise as zero mean and computing its standard deviation directly from the sequence of measurements. In the second case, the statistics of the noise may be derived from the BCCH signal-to-noise ratio or possibly from the correction peak or from the TOA estimation process. In the following discussion the first interpretation is considered.

Equation (1) provides a set of measurements of a known quantity (the inter WLS distance), corrupted by a generally fixed and unknown constant (the clock error) and noise with some statistics. If the noise terms is taken to be a Gaussian distribution, the mean value of the noise process can be grafted into the clock error. Since Gaussian processes may be characterized by first and second moments, the only other noise-identifying characteristic needed is the standard deviation. In one embodiment, the standard deviation is derived directly from the measurements by either computing the standard deviation of the TOA directly (if the measurements have large SNR variation amongst each other) or by a weighted scheme. If the expected SNR variation is low on a fixed path 160 between WLS 1 and WLS 2, the former method can be used.

Where the standard deviation is denoted by r₁₂ for a series of measurements made for the TOA (time lapsed foe a BCCH burst to traverse the distance between WLS 1 and WLS 2—during which time the statistics of good/bad WLS does not change) and d₁₂ is the known distance between WLS 1 and WLS 2, then a Maximum Likelihood Estimate (MLE) of clock error can be computed as follows:
a=Σ(1/r₁₂²) (2)
b=Σ((t₁₂−d₁₂)/(r₁₂²)) (3)

The sum includes all BCCH broadcasts from base station 130 to base station 100. The MLE of the clock error for WLS can be determined by:
D₁=b/a (4)

The principles disclosed herein can be equally implemented with a mobile transmitter. In other words, base station 130 can be replaced by a mobile transmitter capable of transmitting a broadcast to WLS 1 and one or both of WLS 2 or master unit 180. If the location of the mobile can be determined at the time of transmission, equations (1)-(4) can be used to assess the clock offset at WLS 1.

The processes outlined above can be implemented at each WLS using conventional microprocessor technology. For example, the outlined algorithm can be implemented with a microprocessor positioned at master unit 180, communicating with each WLS and each base station. The algorithm can be embedded in the microprocessor or implemented on flash basis.

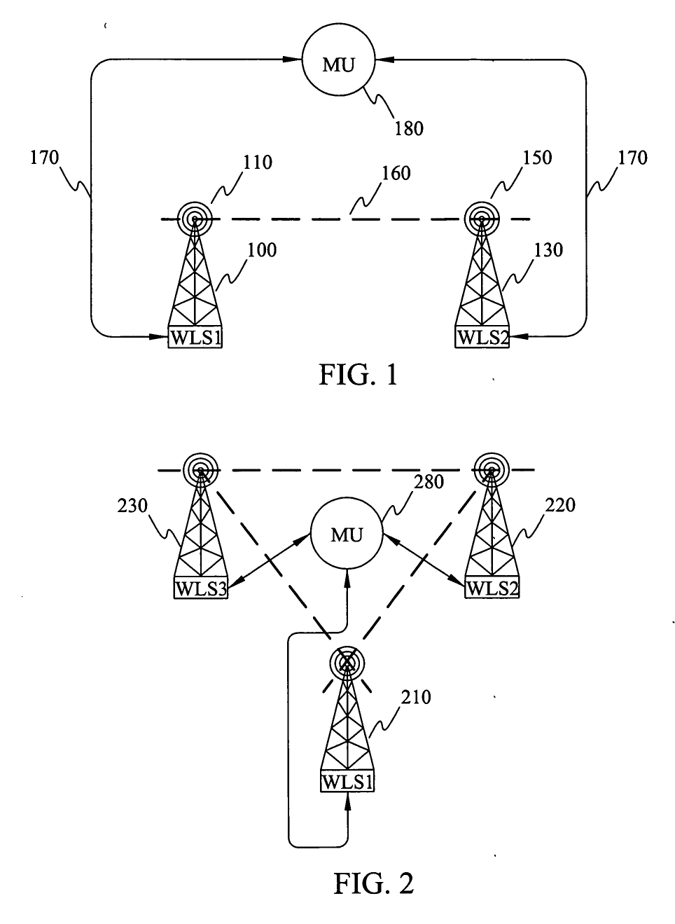

FIG. 2 is a schematic representation of a plurality of wireless transmission stations implementing an embodiment of the disclosure. Referring to FIG. 2, master unit 280 communicates with each of wireless sensors identified as WLS 1, WLS 2 and WLS 3. For simplicity, each wireless sensor is shown to be co-located with a base station. The embodiment of FIG. 2 relates to a machine-readable medium having stored thereon a plurality of executable instructions to be executed by a processor to determine clock error associated with one of a plurality of Wireless Location Sensors. The machine-readable medium and the processor may be located at master unit 280. The method may include communicating with WLS 1, WLS 2 and WLS 3 and determining that, for example, that the internal clock of the WLS 3 is not synchronized with the internal clocks of WLS 1 and WLS 2.

To synchronize the internal clock of WLS 3, master unit 280 may direct each wireless sensor to acquire a first broadcast transmitted from base station 210 and a second broadcast transmitted from base station 220. Next, each WLS can be instructed to report an actual time of arrival of the broadcast according to its internal clock. The master unit can also compute an expected time of arrival at WLS 3 for each of the first and the second broadcasts as a function of the distance between WLS 1, WLS 2 and WLS 3 and at least one of the first or the second transmission stations. More generally, the master unit can compute an expected time of arrival at WLS 3 for each of the first and second broadcasts as a function of the locations of the transmission stations and the WLSs. Next, the master unit can determine a clock error at WLS 3 as a function of the expected time of arrival and the actual time of arrival for at least one of the first and second broadcasts. Finally, master unit 280 can instruct WLS 3 to correct its clock error. In the event that WLS 3 does not have an internal clock, the information provided by master unit 280 can be used to define a time reference. To minimize the effects of noise and other intangible variables, the same measurements can be obtained from multiple broadcasts and the results processed by MLE or other similar algorithms before a final estimate is made.

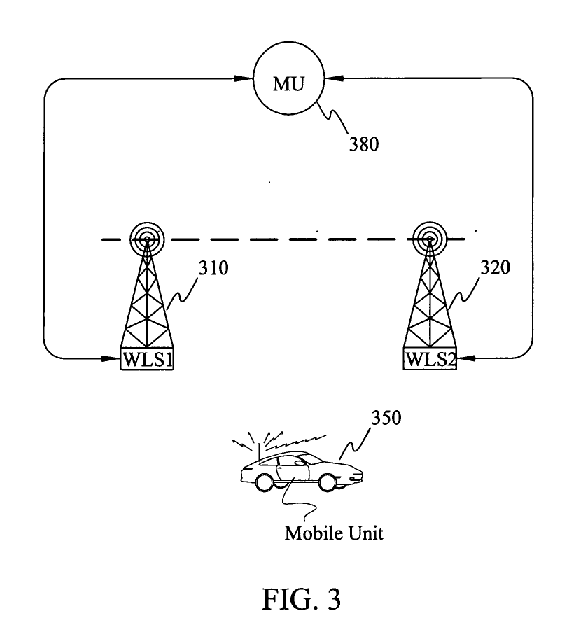

FIG. 3 is a schematic representation of a plurality of wireless transmission stations and a mobile transmission station implementing an embodiment of the disclosure. In the embodiment of FIG. 3, the transmissions from a mobile transmitter can be used to assess and correct clock error of a wireless location sensor. Referring to FIG. 3, WLS 1 and WLS are in communication with master unit 380 as well as with mobile transmitter 350. For simplicity, the wireless sensors are shown as co-located with a base station. As before, a preliminary step in correcting clock error is assessing the existence of an offset. To this end, master unit 380 can identify several wireless sensors and assess good and bad WLS by comparing the reported time of each WLS against a local clock or against other wireless location sensors. Alternately, the WLS can evaluate the status of its own clock and report the status to the MU. Assuming that WLS 1 is found to be asynchronous with WLS 2 (or other wireless sensors not shown), master unit 380 may direct each of WLS 1 and WLS 2 to detect a broadcast transmitted from mobile unit 350 and report the time of arrival of the transmission at each sensor. Using conventional algorithms and the TOA from the wireless sensors known to have a synchronous clock, the master unit can compute the location of mobile unit 350. Next, the master unit can compute the expected TOA of the broadcast at the first WLS as a function of the distance between each of WLSs and the mobile transmitter. Finally, master unit 380 can determine the clock error associated with WLS 1 as a function of the expected time of arrival and the actual time of arrival of the broadcast at WLS 1.

In the event that a plurality of wireless sensors having synchronous time is unavailable, the algorithm can still be implemented if the location of the mobile is known. To this end, the mobile can announce its location and master unit 380 can assess clock error at WLS 1 as a function of the expected time the mobile unit's signal would arrive at WLS 1 and the distance between mobile unit 350 and WLS 1. To minimize the effects of noise and other intangible variables, the same measurements can be obtained from multiple broadcasts, including those from several different reported locations of the mobile, and the results processed by MLE or other similar algorithms before a final estimate is made.

As stated, multipath can affect clock error calculations. Multipath transmission occurs when the transmission path between two points takes a path different from the straight line distance between the two points. In one embodiment, the disclosure is directed to addressing the inaccuracies associated with multipath between two or more wireless sensors.

Following similar mathematical notation, the clock in error denoted by i, and the set of correct clocks available for synchronizing the incorrect clock denoted by k=1,2 . . . K. Let the clock error at i be Δᵢ. Then, in measuring the TDOA for a transmission emanating from correct clock k and received at incorrect clock i, we have
Tᵢ=Tₖ+dₖᵢ+Δᵢ+nₖᵢ+mₖᵢ (5)
where Tᵢ and Tₖ are the time stamps at i and k generated at the wireless sensor's internal clocks, nₖᵢ is the noise on the transmission path from k to i and mₖᵢ is the multipath-generated excess distance (i.e., in excess of a straight line distance) on the signal path from k to i. Rearranging terms of equation (5) results:
   Δᵢ=[Tᵢ−Tₖ]−dₖᵢ−nₖᵢ−mₖᵢ (6)

In measuring the TDOA for a transmission emanating from the vicinity of incorrect clock i and received at correct clock k, results:
Tₖ=Tᵢ+dₖᵢ−Δᵢ+nᵢₖ+mᵢₖ (7)
where nᵢₖ is the noise on the transmission path from k to i. Rearranging the terms of equation (7) results:
   Δᵢ=[Tᵢ−Tₖ]+dₖᵢ+nₖᵢ+mₖᵢ (8)

Both equations for Δᵢ offer estimates of the clock error Tᵢ−Tₖ, which in the absence of noise, may be polluted by the distance and multipath. The distance term is equal in both directions, and is known. The multi path terms mᵢₖ and mₖᵢ may be different since the propagation paths need not be identical. One observation is that the multipath terms shift the estimate of Δᵢ differently in that in one case the estimate is increased and in the other case the estimate is decreased. The multipath shifting property, when viewed over the two directions of transmission, can improve the clock error estimate. A different observation is as follows: Let Tᵢ and Tₖ denote not the time stamps recorded in the Time Difference of Arrival (TDOA) estimation process but rather a set of “corresponding time stamps” as observed by an extraneous observer. That is, an extraneous observer who can determine what each clock reads at a given moment in universal time, records these contemporaneous values. Next, let Δᵢ denote the TDOA for a transmission from incorrect clock i to correct clock k:

$$\begin{matrix}{Δ}_{1} = [ {T}_{k} + {d}_{ik} + {m}_{ik} ] - {T}_{i} + {n}_{ik} \\ & ( 9 ) \\ = - {Δ}_{i} + {d}_{ik} + {m}_{ik} + {n}_{ik} & ( 10 ) \\ Thus , & \\ - {Δ}_{1} + {d}_{ik} = {Δ}_{i} - {n}_{ik} - {m}_{ik} & ( 11 )\end{matrix}$$

The right hand side of equation (11) is the clock error corrupted by noise and a negative multipath term, while the left hand side of the equation is fully determined. Now consider a transmission from correct clock k to incorrect clock i. Then,

$$\begin{matrix}{Δ}_{2} = [ {T}_{i} + {d}_{ki} + {m}_{ki} ] - {T}_{k} + {n}_{ki} & ( 2 ) \\ = {Δ}_{i} + {d}_{ki} + {m}_{ki} + {n}_{ki} & ( 13 ) \\ {Δ}_{2} - {d}_{ki} = {Δ}_{i} + {n}_{ki} + {m}_{ki} & ( 14 )\end{matrix}$$

The right hand side of the equation is the clock error corrupted by noise and a positive multipath term; whereas the left hand side of the equation is fully determined. The effect of multipath on estimating clock error when examined over a set of transmissions in one direction versus the other direction can be seen to shift the estimate differently: positively for one direction of measurement and negatively for the other. When multiple measurements are performed if estimates for the clock error are maintained separately for the two directions of measurement, clusters of measurements separated by a mean distance equal to the sum of the multipath on each directional path can be observed as follows:
Cᵢₖ=E[Δ₂+Δ₁−2dᵢₖ] (15)
where E denotes expected value or mean. If all measurements were lumped together, the separation of the clusters will not be observed. Thus, according to one embodiment of the disclosure, the multipath effects can be mitigated by forming large clusters of good and bad WLS. Thus, in one embodiment the disclosure is concerned with the determination of multipath and its magnitude by observing the cluster separation. In another embodiment, the disclosure is concerned with improving the clock error estimate by utilizing parameters of the determined multipath. As before:
   Δᵢ=b/a (16), where
   a=Σ(1/σ²ᵢₖ) (17)
   b=Σ(ψᵢₖ/σ²ᵢₖ) (18)

Each of equations (17) and (18) is a summed over k wireless sensors and where ψᵢₖ can be the TDOA estimates as discussed above as either −Δᵢ+dᵢₖ or Δ₂−dₖᵢ. The quantities σᵢₖ are the standard deviations or similar property of the noise measurement of the i-k clock to clock signal path. The term σᵢₖ can be modified for each i-k path to reflect the effect of multipath.

Since multipath affects the clock error estimate negatively, one exemplary approach can be modifying the standard deviation terms for either direction by the cluster separation (i.e., Cᵢₖ) and replace σ²ᵢₖ as follows:
σ²ᵢₖ+Cᵢₖ² (19)

In effect, the paths suffering from multipath have their associated contribution to the clock error estimate diminished by the modification of the last equation. That is, the paths with low multipath dominate the clock error estimate calculation.

Thus, one embodiment the disclosure relates to a method for determining clock error associated with one of a plurality of wireless location sensors. The method includes identifying a first, a second and a third WLS in communication with the processor and directing each WLS to acquire a first broadcast transmitted from a first transmission station and a second broadcast transmitted from a second transmission station. Each WLS may report an actual time of arrival at each of the first, second and third WLS prior to computing an expected time of arrival at the third WLS for each of the first and the second broadcast as a function of the distance between the third WLS and at least one of the first or the second transmission stations. Next, the expected time of arrival at the third WLS is adjusted to offset multipath propagation distance. Finally, the clock error at the third WLS can be estimated as a function of the adjusted expected time of arrival and the actual time of arrival for at least one of the first and second broadcast.

The multipath effect associated with a particular wireless sensor can be used to derive a weighing factor (or adjustment coefficient) to be used in future computations concerning the wireless sensor. To this end, a processor can be programmed with machine-executable instructions for weighting the location information provided by one of wireless location sensors (WLS) in a wireless network. The instructions can include (1) identifying a first, a second and a third WLS in communication with the processor; (2) directing each WLS to acquire a first broadcast signal transmitted from a first transmission station and a second broadcast signal transmitted from a second transmission station, each WLS reporting an actual time of arrival at each of the first, second and third WLS; (3) computing an expected time of arrival at the third WLS for each of the first and the second broadcast signals as a function of the distance between the third WLS and at least one of the first or the second transmission stations; (4) adjusting the expected time of arrival at the third WLS to offset multipath propagation distance; (5) determining a clock error offset at the third WLS as a function of the adjusted expected time of arrival and the actual time of arrival for at least one of the first and second broadcast; and (6) using the clock error offset to computed a weighing factor for location assessment associated with the third WLS.

Still further, the known multipath effect associated with a particular wireless sensor can be used to adjust clock error in a wireless location sensor. Thus, according to another embodiment, the disclosure relates to a method for determining multipath interference between a pair of Wireless Location Sensors in a network of multiple wireless sensors. The method including (1) identifying a first WLS and a second WLS capable of communication with each other; (2) transmitting a first plurality of signals from the first WLS to the second WLS; (3) defining a first group of times of arrival of the first plurality of signals received at the second WLS; (4) transmitting a second plurality of signals from the second WLS to the first WLS; (5) defining a second group of times of arrival of the second plurality of signals received at the first WLS; and (6) determining the presence of multipath interference between the first and second WLS as a function of the first and second groups. The steps can be enhanced by determining the magnitude of the multipath interference as a function of a distance between the first and second WLS. The magnitude of multipath can also be used to assess an adjustment coefficient for communication.

In still another embodiment, the disclosure relates to a method of using multiple successive over-determined location events to estimate the offset errors associated with a wireless sensor having an asynchronous clock. The process can estimate errors for one, many or all or all WLS clocks within a network. The number of location events, the diversity of sites participating in the events and the number of sites participating in the location events increases as the number of WLS offset errors to be corrected increases. An exemplary process according to this embodiment is as follows. Either through informal tasking of the location system by outside applications requesting location data (e.g., E911 calls or location enabled commercial location services), or through internally generated location requests, a particular mobile unit can be scheduled to be located. To this end, some set of WLS units are tasked to participate in the location event and attempt to measure TOA on the mobile of interest. Some subset of the WLS units successfully measure a TOA and report to a central site (master unit) for location estimate calculations. The WLS units also provide the central site with the current quality of their internal clock based on measurements made by the GPS receiver in the WLS unit, including number of satellites visible, geometry of the satellites, time since last update, etc. If the time reference quality of WLS units is high enough, then the TOA measurements will be used in the location calculation. If the time reference quality is not high enough, then the central unit will use the location event and others reported from the WLS to create a correction offset for the unit's reported time.

The offset can be calculated by using the calculated location of the mobile based on good WLS units (or TOA measurements from WLS units that have valid correction offsets from previous location event processing.) The offset can “correct” the TOA so that if it was used in the location calculation, it would yield a surface (TOA/TDOA) consistent with the mobile calculated location. Each event that yields information to refine the correction offset (or when multiple events are used in combination to solve multiple correction offset unknowns) allows a more refined correction offset. The central unit thus keeps a table of the quality of WLS clocks, and for WLS units with unacceptable quality clocks, a correction offset. WLS units with unacceptable clock quality are flagged to be ignored in location calculations. Instead, location calculations are used to generate correction offsets for such WLS units.

### EXAMPLE

The following example is provide for illustrative purposes and is not to be construed as limiting the principles disclosed herein. Consider that there are four wireless sensors indexed by 1, 2, 3 and 4. Consider the position coordinates for the sensors, respectively, as (5, 5), (0, 0), (20,0) and (5, 15) and measured in microsecond equivalents (actual distances divided by the speed of electromagnetic wave). Also, assume that WLS 1 either has no clock or has a bad clock and that the error is 0.5 microseconds. All wireless sensors maintain synchronization with the BCCH of their co-located base station.

The master unit, which is continuously updated on the clock status of the WLSs, then instructs WLS 2, 3 and 4 to store the equivalent data for a series of BCCH data bursts with associated timing information and simultaneously instructs WLS 1 to tune in and acquire data associated with these BCCHs. The master unit also instructs WLS 1 to perform the necessary algorithms to generate a TOA (or a time-stamp for the arrival time) for each BCCH burst from each of base stations associated with the good WLSs.

The master unit having gathered either the TOAs or time-stamp information needed to independently generate the TOA information, computes the mean (or median) TOA for bursts from k to WLS i (i=1, 2, 3 and 4). These are denoted by tᵢₖ. The master unit also computes the standard deviation for the TOAs associated with each set of bursts. These are denoted rᵢₖ. Let these values be as follows:
t₁₂=7.5; t₁₃=16.5; t₁₄=10.6;
r₁₂=1.0, t₁₃=1.25; r₁₄=0.75,
where all quantities are in units of microseconds. Since the location coordinates are known, we have
   d₁₂=7.07; d₁₃=14.811; d₁₄=10.00

Now a and b can be calculated: a=3.418 and b=1.937, allowing us to solve for the clock error at WLS 1 as
D=0.567 microseconds

The master unit can then instruct WLS 1 to correct its clock by 0.567 microseconds. It should be noted hat if perfect measurements were possible and there were no noise, this quantity would have been −0.500 microseconds.

The embodiments disclosed herein are exemplary in nature and are not intended to limit the scope of the disclosure. The principles of the disclosure are intended to include these and other embodiments as well as any permutation or modification thereof.

1. A processor for detecting clock error of a wireless location sensor (WLS) in a communication network having several wireless sensors, the processor programmed with instructions for determining clock error of an asynchronous WLS, the instructions comprising:
identifying a first WLS having asynchronous clock and a second WLS having synchronous clock;
directing each of the first and the second WLS to detect a broadcast transmitted from a transmission station of known location and report an actual time of arrival at each of the first and the second WLS;
computing an expected time of arrival of the broadcast at the first WLS as a function of the distance between the first WLS and the second WLS; and
determining a clock error at the first WLS as a function of the expected time of arrival and the actual time of arrival of the broadcast at the first WLS.

2. The processor of claim 1, wherein the transmission station is substantially co-located with the second WLS.

3. The processor of claim 1, wherein the transmission station is a base station.

4. The processor of claim 1, wherein the transmission station is a mobile transmitter with a known location.

5. The processor of claim 1, further comprising instructing the first WLS to correct clock error.

6. The processor of claim 1, wherein the expected time of arrival is a function of the signal propagation distance between the transmission station and at least one of the first or the second WLS.

7. The processor of claim 1, wherein the steps of directing each of the first and the second WLS to detect the broadcast is implemented sequentially.

8. The processor of claim 1, further comprising identifying a duration for detecting the broadcast.

9. The processor of claim 1, wherein the broadcast is a BCCH.

10. The processor of claim 1, wherein the step of determining a clock error at the first WLS is a function of the expected time of arrival and an average of multiple expected and actual time of arrivals of multiple broadcasts.

11. An apparatus comprising the processor of claim 1.

12. A machine-readable medium having stored thereon a plurality of executable instructions to be executed by a processor to determine clock error associated with one of a plurality of Wireless Location Sensors (“WLS”), the method comprising:
identifying a first and a second WLS having synchronous clocks and a third WLS having an asynchronous clock in communication with the processor;
directing each WLS to acquire a first broadcast transmitted from a first transmission station and a second broadcast transmitted from a second transmission station, each WLS reporting an actual time of arrival at each of the first, second and third WLS;
computing an expected time of arrival at the third WLS for at least one of the first or the second broadcasts as a function of the distance between the third WLS and a corresponding transmission station; and
determining a clock error at the third WLS as a function of the expected time of arrival and the actual time of arrival for at least one of the first and second broadcast.

13. The machine-readable medium of claim 12, wherein the first transmission station is substantially co-located with the first WLS and the second transmission station is substantially co-located with the second WLS.

14. The machine-readable medium of claim 12, further comprising instructing the third WLS to correct clock error.

15. The machine-readable medium of claim 12, wherein the expected time of arrival is further a function of the signal propagation distance between the transmission stations and the third WLS.

16. The machine-readable medium of claim 12, wherein each of the first and the second broadcast defines a BCCH.

17. The machine-readable medium of claim 12, wherein the clock error defines a maximum likelihood estimate based on the actual time of arrival of the first and the second broadcast at the third WLS.

18. The machine-readable medium of claim 12, wherein the clock error defines a maximum likelihood estimate based on the actual time of arrival at the third WLS of a plurality of broadcasts transmitted from the first and the second transmission station.

19. The machine-readable medium of claim 12, wherein the clock error defines an average value of multiple actual time of arrival at the third WLS of multiple broadcasts from the first or the second transmission stations.

20. An apparatus programmed with the machine readable medium of claim 12.

21. A processor for detecting clock error of a wireless location sensor (WLS) in a communication network having several wireless sensors, the processor programmed with instructions for determining clock error of an asynchronous WLS, the instructions comprising:
identifying a first WLS having asynchronous clock and a plurality of WLS having synchronous clocks, each WLS having a known position;
directing each of the first and the second plurality of WLS to detect a broadcast transmitted from a mobile transmission station and report an actual time of arrival at each of the first and the plurality of WLS;
determining an approximate location for the mobile transmitter at the time of transmission from the time of arrival at the plurality of WLS;
computing an expected time of arrival of the broadcast at the first WLS as a function of the distance between the first WLS and the mobile transmitter; and
determining the clock error of the first WLS as a function of the expected time of arrival and the actual time of arrival of the broadcast at the first WLS.

22. The processor of claim 21, further comprising instructing the first WLS to correct clock error.

23. The processor of claim 21, wherein the expected time of arrival is further a function of the signal propagation distance between the mobile transmitter and the first WLS.

24. The processor of claim 21, wherein the steps of directing each of the first and the plurality WLS to detect the broadcast is implemented sequentially.

25. The processor of claim 21, wherein further comprising identifying a duration for detecting the broadcast.

26. The processor of claim 21, wherein the broadcast is a beacon.

27. The processor of claim 21, wherein the step of determining a clock error at the first WLS as a function of the expected time of arrival and an average of multiple actual time of arrivals of multiple broadcasts.

28. An apparatus comprising the processor of claim 21.

29. A machine-readable medium having stored thereon a plurality of executable instructions to be executed by a processor to determine multipath interference between a pair of Wireless Location Sensors (“WLS”) in a wireless network having a plurality of WLSs, the method comprising:
identifying a first WLS and a second WLS capable of communication with each other;
transmitting a first plurality of signals from the first WLS to the second WLS;
defining a first group of times of arrival of the first plurality of signals received at the second WLS;
transmitting a second plurality of signals from the second WLS to the first WLS;
defining a second group of times of arrival of the second plurality of signals received at the first WLS;
determining the presence of multipath interference between the first and second WLS as a function of the difference in the clock error derived from the first and second groups.

30. The machine-readable medium of claim 29, further comprising determining the magnitude of the multipath interference as a function of a distance between the first and the second groups.

31. The machine-readable medium of claim 30, using the magnitude of multipath to assess an adjustment coefficient for communication between the first group of WLS and the second group of WLS.

32. The machine-readable medium of claim 31, further comprising using the adjustment coefficient for subsequent time of arrival measurements from the first group of WLS.

33. The machine-readable medium of claim 32, wherein the step of computing a clock error associated with the first or second WLS from the determined magnitude.

34. A machine-readable medium having stored thereon a plurality of executable instructions to be executed by a processor to determine a clock error associated with a first wireless location sensor (WLS) in a network of a plurality of wireless location sensors, the method comprising:
identifying a mobile transceiver in communication with the first WLS and a plurality of secondary location sensors;
assessing the location of the mobile as a function of signal propagation time between the mobile and the secondary location sensors;
assessing the location of the mobile transmitter as a function of signal propagation time between the mobile and the first WLS;
determine a location offset from the location of the mobile as assessed by each of the first WLS and the secondary sensors;
determining the clock error for the first WLS as a function of the location offset and the distance between the mobile transmitter and the first WLS.

35. The machine-readable medium of claim 34, wherein the step of assessing the location of the mobile transmitter is implemented using time difference of arrival algorithm.

36. The machine-readable medium of claim 34, wherein the step of assessing the location of the mobile transmitter is implemented using angle of arrival algorithm.

37. The machine-readable medium of claim 34, further comprising instructing the first WLS to correct clock error.

38. An apparatus comprising a processor programmed with the executable instructions of claim 43.
